(19) United States
(12) Patent Application Publication
(10) Pub. No.: US 2014/0070004 A1
(43) Pub. Date: Mar. 13, 2014

(54) SYSTEM AND METHOD FOR INVENTORY COUNTING CONTROL

(71) Applicants: John R. FRENCH, La Mesa, CA (US); Robert Martin HARLING, Valley Center, CA (US)

(72) Inventors: John R. FRENCH, La Mesa, CA (US); Robert Martin HARLING, Valley Center, CA (US)

(73) Assignee: CARTTRONICS, LLC, San Diego, CA (US)

(21) Appl. No.: 13/610,559

(22) Filed: Sep. 11, 2012

(51) Int. Cl. G06Q 30/00

(52) U.S. Cl. 235/385

(57) ABSTRACT

A system and method are provided for monitoring and recording the movements of a plurality of mobile units in an environment in which more than one type of mobile unit is present. For inventory control, an emitter tag is mounted on each mobile unit. Initially, the mobile units are physically sorted by type and each emitter is read to input each mobile unit's unique tag identifier and the corresponding mobile unit type (setup data) into computer readable memory at a base station. For the system, a plurality of remote stations, each having a limited signal receiving range, are strategically positioned in the environment. Each remote station receives in-range emitter signals and communicates the occurrence of mobile unit movements (operational data) to the base station. The operational data can be used together with the setup data described above to generate mobile unit movement reports for each mobile unit type.

### FIELD OF THE INVENTION

The present invention pertains generally to systems and methods for monitoring an inventory of mobile units as they are used and moved within a monitored environment. More particularly, the present invention pertains to systems that detect and record the movement of shopping carts in a shopping environment in which different types of carts are present. The present invention is particularly, but not exclusively, useful as a system for managing an inventory of shopping carts that identifies each cart, by type, to create and maintain a cart movement history, as well as statistics for each cart type.

### BACKGROUND OF THE INVENTION

At many retail establishments, shopping carts are provided for the convenience of shoppers. In general, these carts expedite the shopping experience by allowing goods to be efficiently selected, purchased and then moved from the establishment to a shopper's vehicle. Most stores now have several different types of carts available to shoppers. For example, at a grocery store, one may now expect to find mobility carts to assist handicapped individuals, child ride-along carts, oversized carts, and hand-baskets in addition to standard grocery carts. As another example, at a typical home improvement center, the different types of carts may include standard grocery-style carts, flatbed carts for heavy items and lumber carts.

There are many reasons why it may be desirable to monitor shopping cart movements. This is particularly true when different types of carts are present at an establishment. For one, a monitoring system may alert a store manager or other responsible individual that the number of carts of a particular type that are available for newly arriving shoppers (i.e. at the front of the store) is low or that an excessive number or carts of a particular type have been abandoned in the parking lot. In addition, an inventory system can provide an indication that one or more carts are missing or have been stolen. Unfortunately, many carts and baskets are “borrowed” and lost to a store either temporarily or permanently. Therefore, almost universally, retailers have needed to purchase excess inventories of carts etc., to make up for the variable, unmanaged “float” of carts etc. that were offsite, lost or undergoing maintenance/repair and not available for customer use at any particular time. In fact, some retail industry operators estimate that from 10% up to 30% of cart inventories are “excess” to actual needs.

Store operators also frequently transfer carts from one store or region to make up for a perceived or actual shortage at another location, which further reduces the ability to quantify and manage the retailer's costly cart and basket inventory without an accurate cart inventory system. Cart retention programs to reduce theft combined with an inventory system which provides a retailer with actual knowledge of how many carts that they own, preferably by cart type, and the condition of each cart can help to minimize the number of excess carts a retailer must purchase and maintain.

In addition to the advantages described above, a cart inventory system can be used to reduce the overall maintenance and replacement costs of an inventory of shopping carts. For example, the duration that a specific cart has been used, as well as the distance traveled by the cart, may be recorded and maintained in order to plan maintenance activities or to determine when to discontinue use of the cart. As another example, an inventory system may identify a broken or disabled cart, as these carts may be consistently left unused at the cart corral in the front of the store.

In addition to maintenance concerns, records of cart movement may be analyzed for operational purposes. This is particularly true when different types of carts are available and tracked by cart type. For instance, the movement of a particular type of cart through a retail establishment may be recorded to help in planning where to position goods within a store. Furthermore, aisle design and store layout may be modified in response to cart movement trends. Also, the recorded number of carts in use at certain times of the day can be used to determine the number of carts provided for use and, correspondingly, the number of carts that may be removed for maintenance. In addition, correlation between the type of cart and a cart usage area may also indicate that adding carts of a certain type may be useful to shoppers. Moreover, the recorded movement of carts can provide information relating to shoppers' behavior.

In light of the above, it is an object of the present invention to provide systems and methods for monitoring an inventory of mobile units or personnel or property, assets or equipment in an environment which employs several different mobile unit types. Another object of the present invention is to provide a system and method that identifies a time and location for each shopping cart in an inventory of carts and stores the data together with the type of cart. Yet another object of the present invention is to provide a method for quickly and efficiently establishing a cart monitoring system at a site employing different types of carts. Still another object of the present invention is to provide a computerized system and method that automatically monitors and records the movement of each shopping cart as the cart travels past a plurality of monitored locations. It is another object of the present invention to provide a cart inventory control system and method that is easy to implement, is cost effective and is simple to use.

### SUMMARY OF THE INVENTION

The present invention is directed to a system and method for monitoring and recording the movements of a plurality of mobile units in an environment in which more than one type of mobile unit is present. For instance, the system can track the movements of mobile units, such as different types of shopping carts in a store environment, or different types of medical equipment (e.g. wheel chairs, IV stands, and gurneys) in a hospital environment. The recorded data can then be used to provide reports to a user including information that is sortable by the type of mobile unit.

In one aspect of the present invention, a method for establishing an automated, computerized monitoring system for a plurality of mobile units is provided. More specifically, the method establishes a system which can simultaneously collect movement data for several different types of mobile units and generate reports that are sortable by mobile unit type. To establish such a system, an emitter is attached to each mobile unit. For the system, each emitter transmits a signal encoding a unique tag identifier for the mobile unit that can be sensed by a receiving station. As detailed further below, the emitter may transmit its signal periodically, may transmit its signal upon interrogation by a receiving station, or both.

During initial system setup, the mobile units are physically sorted by type. Then, with the emitters attached to each mobile unit, each emitter is read to initially input each mobile unit's unique tag identifier and the corresponding mobile unit type into computer readable memory. For instance, a database architecture may be used to store and manipulate this information. Typically, the computer and memory are located at a centralized base station that is located somewhere within the environment (e.g. on the store premises or at a hospital site), however, in some cases, these items can be located offsite. Once the unique tag identifiers for all of the mobile units of a particular type have been registered in computer memory, the unique tag identifiers for second type of mobile unit can be entered, and so on. This process is then continued until the unique tag identifiers for all of the mobile units have been initially entered into computer readable memory.

For the present invention, the base station is placed in communication with a plurality of remote stations. Each remote station can receive signals from nearby emitters. More specifically, each remote station is strategically placed at a particular location and has a range that corresponds generally to a selected area within the environment. In some cases, the remote station's range may be adjustable. When a mobile unit is within a remote station's range, a signal from the mobile unit's emitter will be received by the remote station. On the other hand, if a mobile unit is outside a remote station's range, a signal from the unit's emitter will not be received by the remote station. The receipt of a tag signal by a remote station at a particular time is herein termed an “event”. For the system, each remote station communicates events to the base station, either immediately upon occurrence, according to a uniform periodic schedule or upon receiving a transfer request from the base station.

After setup, the automated, computerized monitoring system can function to record and store operational data for mobile units of differing types as they are used and moved from place to place within the environment. The operational data can be used together with the setup data described above to generate mobile unit movement reports for each mobile unit type. These reports can include the length of time that a particular mobile unit is in a particular area and the total distance that a particular mobile unit has travelled in a particular period. The data for each mobile unit can then be aggregated and sorted by mobile unit type to generate usage and movement reports for each type of cart. For example, the average distance mobile unit of a particular type has travelled in a selected time period can be reported.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an overhead, simplified view of an embodiment of a system for controlling an inventory of carts in a retail store environment in accordance with the present invention;

FIG. 2 is a schematic drawing illustrating the interaction between a remote station, a passive emitter tag on a mobile unit, a base station and a controller in the system of FIG. 1;

FIG. 3 is a schematic drawing illustrating the interaction between a remote station, an active emitter tag on a mobile unit, a base station and a controller in the system of FIG. 1;

FIG. 4 is a schematic diagram illustrating the storage of setup and operational data into computer readable memory and the use of stored data to prepare reports; and

FIG. 5 is an overhead schematic view of an embodiment of a system for controlling an inventory of medical apparatus in a hospital environment in accordance with the present invention.

### DESCRIPTION OF THE PREFERRED EMBODIMENTS

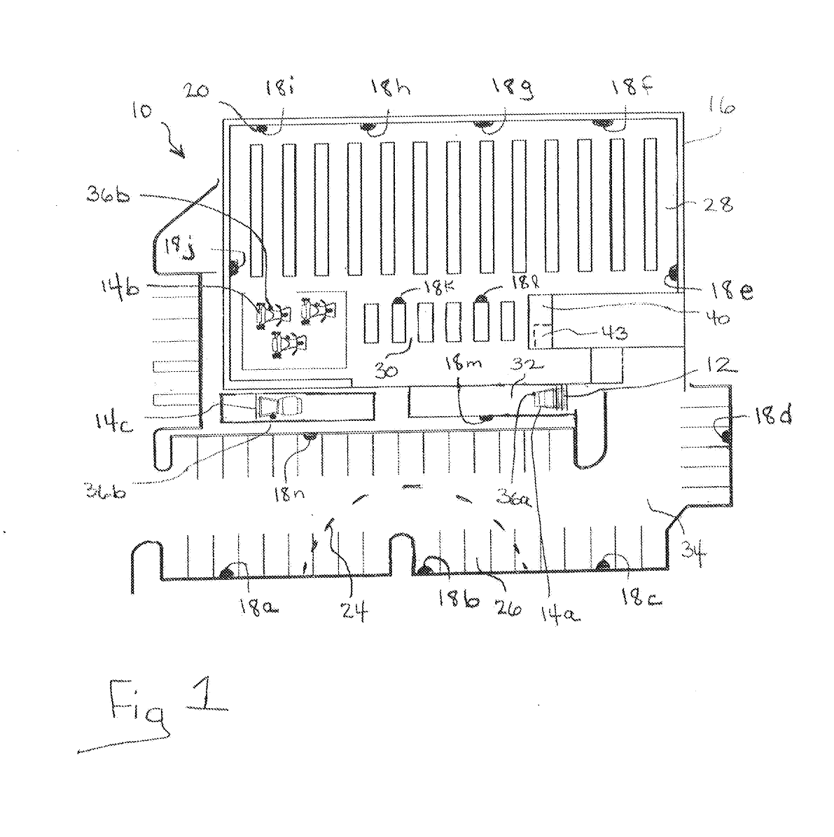

Referring to FIG. 1, a mobile unit inventory control system is shown, and is generally designated 10. As described herein, the system 10 is used to monitor the movement of an inventory 12 of mobile units, such as shopping carts 14a-c, in an environment 16, such as a retail store property. As shown in FIG. 1, the mobile units can be different types of shopping carts 14a-c including standard grocery-style carts 14a (having a wire mesh basket and caster wheels), motorized mobility carts 14b to assist handicapped individuals, and child ride-along carts 14c (having a plastic child cab/compartment that is attached to a standard cart). In addition to, or instead of these carts which are typically found at a grocery store, other carts such as oversized carts (not shown), flatbed carts (not shown) and lumber carts (not shown) may be monitored, for example, at big box retail outlets and home improvement stores.

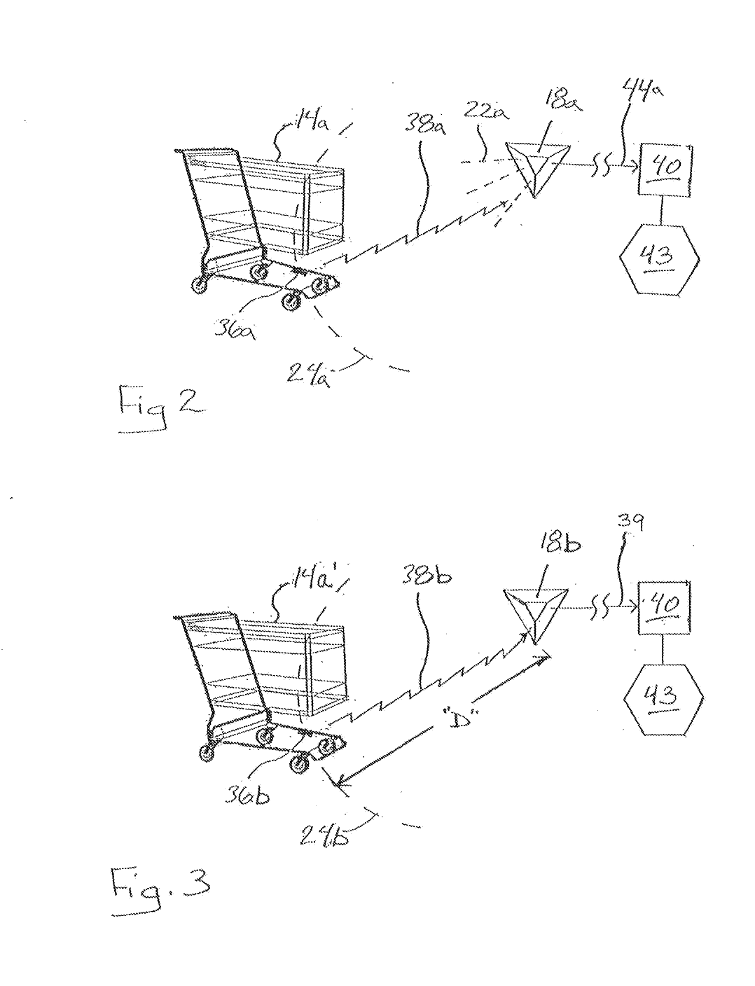

Continuing with FIG. 1, it can be seen that a plurality of remote stations 18a-n can be strategically positioned at predetermined locations 20. In some embodiments, as shown in FIG. 2, these remote stations 18 may broadcast local multi-directional beacons 22 and/or radio frequency identification (RFID) interrogation signals. When used, each beacon/interrogation signal 22 may extend to a boundary 24 that encloses a discrete communication range. In some cases, the remote station ranges may overlap allowing coverage of an entire environment. Further, predetermined locations 20 for the remote stations 18 are selected so that the range boundaries 24 enclose ranges within distinct areas 26 in the environment 16, including choke points within the in-store area 28, the checkout aisle area 30, the corral area 32, the parking lot area 34, and maintenance areas (not shown).

Cross-referencing FIG. 1 with FIG. 2, an emitter tag 36a-c is attached to each cart 14a-c to transmit a signal encoding a unique tag identifier (tag signal) to the remote stations 18 (and in some cases receive beacon/interrogation signals from remote stations—see below). Specifically, each radiofrequency or infrared emitter tag 36a-c provides a unique identification for each cart 14a-c. Generally, for the present invention, the emitter tags 36a-c can be attached at any location on the cart 14a-c.

In a first implementation, illustrated by FIG. 2, passive emitter tags 36 are adapted to receive the local multi-directional beacons 22 from a remote station 18 when they are within range of the respective station's beacon 22. Upon receiving the beacon 22, the emitter transmits a signal that is then received by the remote station. For this implementation, the range of each remote station 18 can be limited by either the beacon signal or the emitter signal, depending on the relative signal strengths. It's also possible that one beacon signal could initiate responses from two (or more) emitters that are then received by two (or more) remote stations.

In a particular implementation, the emitter tags 36 are passive RFID emitters adapted to receive RFID interrogation signals 22 from a remote station 18 when they are within range of the respective remote station 18. Upon receiving the RFID interrogation signals 22, the RFID emitter transmits a signal that is then received by the remote station 18. For this implementation, the range of each remote station 18 can be limited by either the RFID interrogation signal or the passive emitter signal, depending on the relative signal strengths. The RFID emitters may be powered by an on-board battery or energized by the interrogation signal.

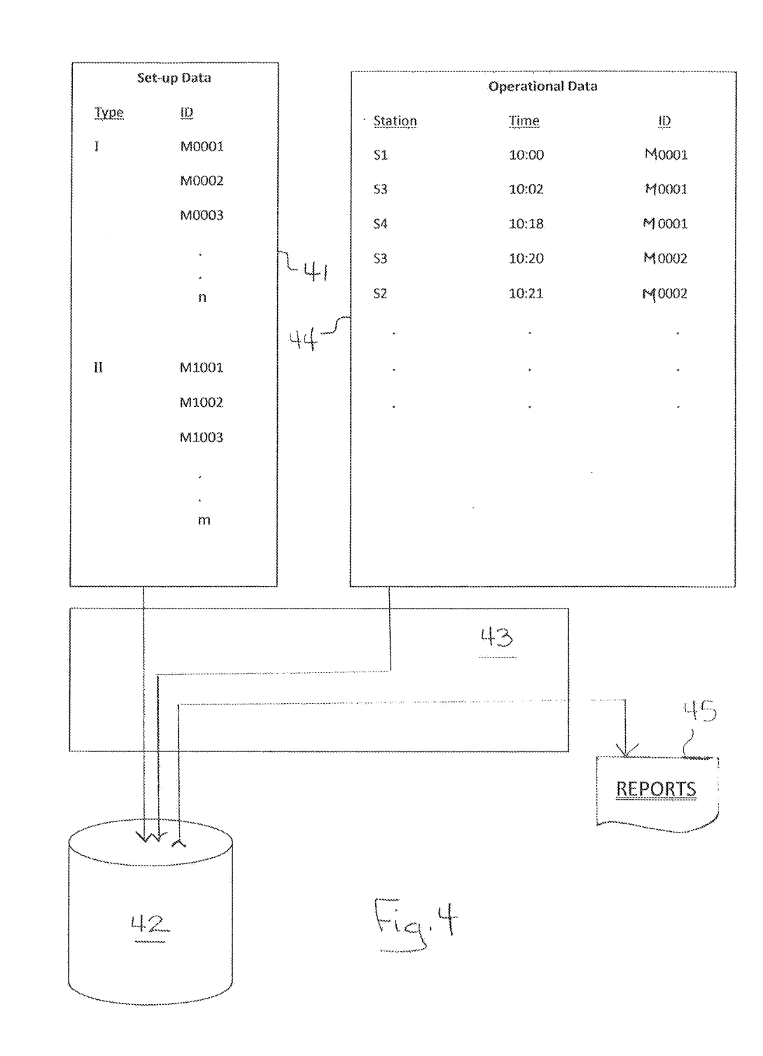

In another implementation, as illustrated by FIG. 3, the emitter tags 36 are designed to actively transmit a tag signal 38 to the remote station 18 periodically, and without a beacon or interrogation signal. In this case, the signal strength of the emitter signal is selected to define an appropriate range for each remote station 18.

In yet another implementation, (not shown) the emitter tags 36 are designed to both actively transmit a tag signal 38 to the remote station 18 periodically and transmit a signal upon receipt of a beacon or interrogation signal.

Referring back to FIG. 1, the system 10 further includes a base station 40 which is in communication with each remote station 18 (via wire or wireless communication). As a result, each remote station 18 is able to convey to the base station 40 that a tag signal 38 has been received from a tag 36. In practice, the remote stations 18 may communicate the received tag signals 38 to the base station 40 as they arrive, or at scheduled intervals. In some cases, the remote stations 18 may only communicate to the base station 40 the arrival and departure of an emitter tag to the operable range of the remote station. For example, a departure may be sensed by a remote station by the failure of an emitter to respond to a beacon/interrogation signal or the absence of a signal from a periodic, active emitter tag.

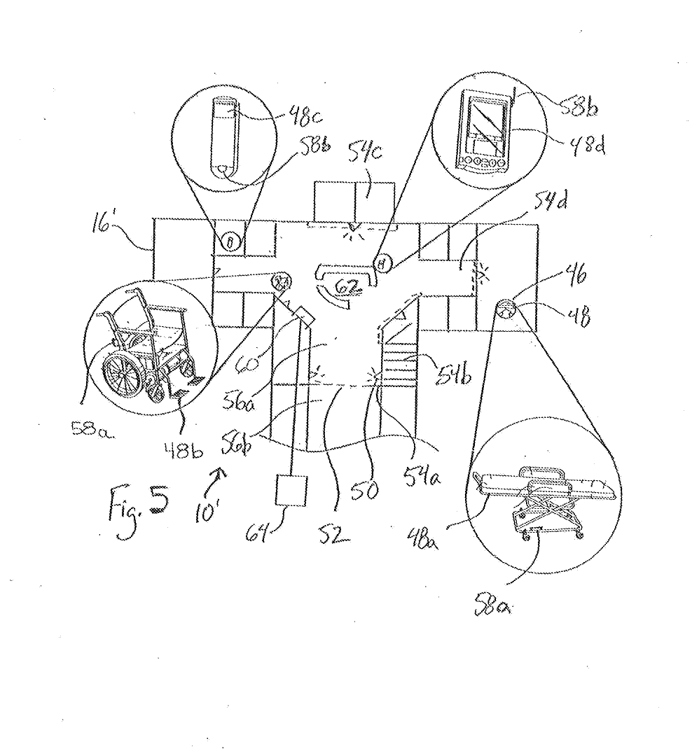

Cross referencing FIGS. 1 and 4, a method for quickly and efficiently establishing a cart monitoring system at a site employing different types of carts is illustrated. For example, during an initial system setup, the carts 14a-c can be physically sorted by type. Then, with the emitter tags 36 attached to each cart 14a-c, each emitter tag 36 for all carts of a first cart type are read, for example, using a handheld reader or at one of the remote stations 18. Once each emitter tag 36 for all carts of a first cart type are read, the carts of a second type are read, etc. until all of the carts 14a-c have been read. This setup data 41 which includes each cart's unique tag identifier (e.g. M0001) and the corresponding cart type can then be placed into computer readable memory 42, for example, using a processor 43 at base station 40. For instance, a software application program such as a database program may be used by processor 43 to store and manipulate (e.g. sort) this information.

Cross referencing FIGS. 1 and 2, the interaction between a remote station 18a, a passive emitter tag 36a, base station 40 and processor 43, after initial setup, and during an operational period is illustrated. Initially, the remote station 18a emits its beacon 22a to the extent of its range boundary 24a. When the cart 14a crosses the range boundary 24a, the tag 36a on the cart 14a receives the beacon 22a. In response, the tag 36a transmits a tag signal 38a back to the remote station 18a. After the tag signal 38a is received by the remote station 18a, the remote station 18a communicates information 44 to the base station 40 indicating, for example, the identity of the tag 36a, the identity of the remote station 18a, and the time the tag signal 38a was received. As shown in FIGS. 2 and 4, the base station 40 conveys this operational data 44 to the processor 43, which, in turn, places the operational data 44 into computer readable memory 42. This output of operational data from the base station 40 to the processor 43 may be over a direct line or through a network connection.

Referring to FIG. 3, another embodiment is shown in which an active emitter tag 36b is used after initial setup, and during an operational period is illustrated. Specifically, in FIG. 3, the interaction between a remote station 18b, an active emitter tag 36b, a base station 40 and a processor 43 in communication with the base station 40 is illustrated. As shown, the active emitter tag 36b emits its tag signal 38b having tag signal that is receivable up to a distance “D” from the emitter tag 36b. Thus, the range boundary 24b for remote station 18b to receive signals from the emitter tag 36b is also at a distance “D” from the remote station 18b. When the cart 14a′ is within the range boundary 24b, the tag signal 38b can be received by the remote station 18b. After the tag signal 38b from the active emitter tag 36b is received by the remote station 18b, the remote station 18b communicates information 39 to the base station 40 indicating, for example, the identity of the tag 36h, the identity of the remote station 18b, and the time the tag signal 38b was received. As shown in FIGS. 3 and 4, the base station 40 conveys this operational data 44 to the processor 43, which, in turn, places the operational data 44 into computer readable memory 42.

While FIG. 1 shows the processor 43 to be located in the store environment 16, it may be offsite. In either case, the processor 43 receives and stores the operational data 44 arriving at the base station 40. In this manner, the system 10 accounts for a complete inventory 12 of carts 14a-c as they are being used and moved from place to place within the environment 16.

With the operational data 44 and setup data 41 in memory 42, the processor can be used to generate mobile unit movement reports 45. A user interface (not shown) can be provided for this purpose. These reports can include data for one or more individual carts, data for all carts, or data for one or more particular cart type. For example, these reports can include the length of time that a particular mobile unit is in a particular area and the total distance that a particular mobile unit has travelled in a particular period. Average statistics can be reported, for example, sorted by type. As another example, the average time a particular type of cart is in a particular area, or the average total distance a particular cart has travelled in a particular period can be reported. A report can include rankings by distance travelled for carts of a particular type to allow selection of particular carts for maintenance or inspection. A cart count by type can be reported to determine whether any carts are missing or inoperable. This can then be used to ensure that an adequate number of each type of cart is available. Also, the number of carts of a particular type in a particular location such as maintenance or the parking lot can be reported.

Referring now to FIG. 5, the system 10′ can be seen as used in a hospital environment 16′. As shown, the inventory 46 of mobile units 48 includes a variety of different types of mobile units 48 such as gurneys 48a, wheel chairs 48b, diagnostic equipment 48c, and therapeutic equipment 48d.

The method for quickly and efficiently establishing a cart monitoring system at a site employing different types of carts described above can be used to establish a monitoring system for the mobile units 48. For example, during an initial system setup, the mobile units 48a-d can be physically sorted by type. Then, with the emitter tags 58a-b attached to each mobile unit 48a-d, each emitter tag 58a,b for all mobile units of a first mobile unit type are read, for example, using a handheld reader or at a remote station. Once each emitter tag 58a,b for all mobile units 48 of a first mobile unit type are read, the mobile units 48 of a second type are read, etc. until all of the mobile units 48a-d have been read. This setup data which includes each mobile units unique tag identifier and the corresponding mobile unit type can then be placed into computer readable memory (see e.g. FIG. 4).

During normal operations at the hospital environment 16′, such mobile units 48 may be used and moved from one area to another. Thereafter, the mobile units 48 may not be returned, thereby creating a shortage in their original area. The present system 10′ accounts for a complete inventory 46 of mobile units 48 as they are being used and moved from place to place within the hospital environment 16′. In this manner, the system 10′ may provide for asset management information. Further, the system 10′ may prevent removal of certain mobile units 48 from an area. Specifically, the system 10′ may be combined with locking mechanisms mounted to the mobile units 48 to prevent their removal from a selected area.

For this embodiment of the present invention, the system 10′ positions remote stations 50 to define electronic boundaries 52 at the physical boundaries 54 between different areas 56 in the hospital. For instance, remote stations 50 may be located to establish electronic boundaries 52 at doorways 54a between two different hospital units 56a, 56b, at stairwells 54b, at elevators 54c, and at hallways 54d. In this embodiment, the system 10′ also includes different types of receiver/transmitter tags 58. First, the system 10′ includes tags 58a that are mounted on mobile units 48 for monitoring movement of the mobile units 48. Second, this embodiment of the system 10′ also includes tags 58b that are mounted on mobile units 48 and can be activated to prohibit movement of a mobile unit 48. Specifically, movement of certain mobile units 48 between areas 56 may be permitted, but recorded. On the other hand, movement of other types of mobile units 48 between areas 56 may be prohibited. For the latter, in response to the receipt of a beacon from a predetermined remote station 50, the tags 58b will activate a locking mechanism to disable movement of the mobile unit 48. In other words, the beacons emitted by the remote stations 50 will effectively act as a barricade for selected mobile units 48.

Whether intended to monitor or prohibit mobile unit movement, the remote stations 50 will communicate reports 45 to the base station 60 detailing the circumstances surrounding each tag signal received by a remote station 50. As shown, the base station 60 conveys the reports 45 to a controller 64, which may be onsite and directly connected to the base station 60, or offsite and connected through a network. In order to assist in preventing movement of a mobile unit 48 out of its respective hospital area 56, the base station 60 or controller 64 may provide an alert to the nurse's station 62 when there is such an attempt. In this manner, the inventory 46 of mobile units 48 may be monitored and controlled in real time, as well as recorded and analyzed.

While the particular System and Method for Inventory Counting Control as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A system for monitoring an inventory of mobile units in an environment which includes a plurality of mobile unit types, said system comprising:
a plurality of emitter tags, wherein each emitter tag is mounted on a respective mobile unit in the inventory for transmitting a signal encoding a unique tag identifier for the mobile unit;
a base station having data cross-referencing each mobile unit's unique tag identifier and corresponding mobile unit type in computer readable memory;
a plurality of remote stations, with each remote station having a discrete range for receiving signals from emitters within said range, each remote station being placed at a particular location where the range of the respective remote station corresponds to a selected area within the environment, each remote station being in communication with said base station to transfer emitter signals indicating an event characterized by the presence of the emitter tag in the selected area at a particular time; and
a processor connected to the base station for using event information from each remote station to generate mobile unit movement reports for each mobile unit type.

2. A system as recited in claim 1 wherein said mobile units include different types of shopping carts.

3. A system as recited in claim 1 wherein said mobile units comprise at least two types of mobile unit selected from the group of mobile unit types consisting of mobility carts to assist handicapped individuals, child ride-along carts, oversized carts, hand-baskets and standard grocery carts.

4. A system as recited in claim 1 wherein said mobile units comprise at least two types of mobile unit selected from the group of mobile unit types consisting of standard grocery-style carts, flatbed carts for heavy items and lumber carts.

5. A system as recited in claim 1 wherein said mobile units include different types of medical equipment.

6. A system as recited in claim 1 wherein said mobile units comprise at least two types of mobile unit selected from the group of mobile units consisting of medical diagnostic equipment, medical therapeutic equipment, wheel chairs, IV stands and gurneys.

7. A system as recited in claim 1 wherein said data indicative of received emitter signals includes a unique tag identifier, remote station identification, and signal receipt time.

8. A system as recited in claim 1 wherein said mobile unit movement reports for each mobile unit type comprise a report selected from the group of reports consisting of a report ranking mobile units by distance travelled for each mobile unit type and a report of mobile unit count by type.

9. A system as recited in claim 1 wherein each emitter tag is a passive emitter tag.

10. A system as recited in claim 1 wherein each emitter tag is a active emitter tag.

11. A method for monitoring an inventory of mobile units in an environment having a plurality of mobile unit types, said method comprising the steps of:
mounting an emitter tag on each mobile unit in the inventory for transmitting a signal encoding a unique tag identifier for the mobile unit;
providing a plurality of remote stations at predetermined locations in the environment, with each remote station having a discrete range for receiving signals from emitters within said range, each remote station being placed at a particular location where the range of the respective remote station corresponds to a selected area within the environment;
storing setup data cross-referencing each mobile unit's unique tag identifier and corresponding mobile unit type in computer readable memory;
receiving emitter signals indicating an event characterized by the presence of the emitter tag in the selected area at a particular time from each remote station; and
using said setup data and said event information from each remote station to generate mobile unit movement reports for each mobile unit type.

12. A method as recited in claim 11 wherein said mobile units include different types of shopping carts.

13. A method as recited in claim 11 wherein said mobile units comprise at least two types of mobile unit selected from the group of mobile unit types consisting of mobility carts to assist handicapped individuals, child ride-along carts, oversized carts, hand-baskets and standard grocery carts.

14. A method as recited in claim 11 wherein said mobile units comprise at least two types of mobile unit selected from the group of mobile unit types consisting of standard grocery-style carts, flatbed carts for heavy items and lumber carts.

15. A method as recited in claim 11 wherein said mobile units include different types of medical equipment.

16. A method as recited in claim 11 wherein said mobile units comprise at least two types of mobile unit selected from the group of mobile units consisting of medical diagnostic equipment, medical therapeutic equipment, wheel chairs, IV stands and gurneys.

17. A method as recited in claim 11 wherein said operational data includes a unique tag identifier, remote station identification, and signal receipt time.

18. A method for monitoring of an inventory of mobile units having a plurality of mobile unit types in an environment, said method comprising the steps of:
physically sorting the mobile units by mobile unit type in the environment;
mounting an emitter tag on each mobile unit in the inventory for transmitting a signal encoding a unique tag identifier for the mobile unit;
providing a plurality of remote stations dispersed at predetermined locations in the environment, with each remote station having a discrete range for receiving signals from emitters within said range, each remote station being placed at a particular location where the range of the respective remote station corresponds to a selected area within the environment, each remote station being in communication with a base station to transfer emitter signals indicating an event characterized by the presence of the emitter tag in the selected area at a particular time;
receiving an emitter signal from each mobile unit; and
storing data cross-referencing each mobile unit's unique tag identifier and corresponding mobile unit type in computer readable memory.

19. A method as recited in claim 18 wherein the number of mobile unit types is greater than 2.

20. A method as recited in claim 18 wherein said physically sorting step is performed before said mounting, positioning, receiving and storing steps.
